(19) United States
(12) Patent Application Publication
(10) Pub. No.: US 2002/0069777 A1
(43) Pub. Date: Jun. 13, 2002

(54) Printing sleeves and cylinders applied with a photopolymer composition

(75) Inventors: Felice Rossini, Milano (IT); Alfonso C. Nazzaro, Rochester, NY (US); Mohan L. Sanduja, Flushing, NY (US); Carl Horowitz, Brooklyn, NY (US); Zoya Smirnov, Brooklyn, NY (US); Paul Thottathil, New Hyde Park, NY (US)

Correspondence Address: DORITY & MANNING, P.A., POST OFFICE BOX 1449, GREENVILLE, SC, 29602-1449, US

(73) Assignee: Erminio Rossini S.p.A.

(21) Appl. No.: 09/853,034

(22) Filed: May 10, 2001

Related U.S. Application Data
(60) Provisional application No. 60/202,552, filed on May 10, 2000.

(51) Int. Cl. B41C 1/00; B41N 6/00

(52) U.S. Cl. 101/401.1

(57) ABSTRACT

A method of forming a photopolymer layer on a printing substrate (e.g., flexographic printing sleeves and cylinders) is provided. The method includes providing a photopolymer composition that contains a photopolymer and at least one monomer bonded to the photopolymer. The monomer can help reduce the hardness of the resulting photopolymer composition. In addition, the method also includes spraying the photopolymer composition onto a rotating generally cylindrical surface of the printing substrate. In one embodiment, the sprayed photopolymer composition is then cured. The resulting photopolymer layer is seamless and continuous and, in some embodiments, has a hardness of between about 50 to about 70 Shore A.

### RELATED APPLICATION

This application claims priority from U.S. Provisional Application Serial No. 60/202,552, which has a filing date of May 10, 2000.

### BACKGROUND TO THE INVENTION

Flexographic photopolymer printing sleeves and cylinders are often formed with a photopolymer layer. For instance, one method of forming an image on a flexographic printing plate involves laying a virgin, non-cured sheet of photopolymer that is sensitive to ultraviolet light (or actinic light) on a transparent substrate, such as a glass plate. A negative is then placed on top of the photopolymer sheet. Ultraviolet light (or actinic light) is shined on the photopolymer sheet from beneath the glass plate and from above the top of the photopolymer sheet where the negative has been placed. The ultraviolet light (or actinic light) cures (hardens) the underside of the photopolymer sheet and the portions of the top of the sheet that were left unexposed by the negative.

The duration of the exposure of the bottom of the sheet to the ultraviolet light (or actinic light) shining beneath the glass plate typically depends upon the sheet's thickness. On the other hand, the duration of the exposure of the top of the sheet to the ultraviolet light (or actinic light) typically depends upon the depth of the image relief required, which is also referred to as the depth of the sheet's floor from the surfaces that receive and transfer the ink to the printing surface.

The polymerized sheet is then transferred into a solvent bath and scrubbed to remove the unpolymerized (unhardened) portions of the sheet that were not exposed to the actinic ultraviolet light and thus left unpolymerized. Upon removal of the sheet from the solvent bath, the top side of the sheet is left with an image defined by raised surfaces that can receive ink and apply the image to be printed by the printing plate.

As is conventional, sticky backs (double-sided adhesive tapes) are attached to the underside of the sheet bearing the image, and the sheet is then wound around a printing sleeve or cylinder with the bottom of the sheet being attached to the exterior cylindrical surface of the printing sleeve or cylinder. In such a conventional printing plate, there is often a gap where the opposite edges of the imaged sheet come together.

Increasingly, printing jobs require images that are continuous. Examples of such jobs can include gift-wrap, wallpaper, or flexible packaging requiring a continuous image. To satisfy this requirement, the image on the printing sleeve or printing cylinder must normally be continuous. Continuous images are best formed with a printing surface that is continuous and seamless. Accordingly, printing sleeves (or printing cylinders) that carry printing plates with gaps or seams are usually unacceptable.

For example, rolls or sleeves covered with rubber are continuous and seamless and can be engraved by lasers controlled by digital positioning technology in order to remove rubber from designated sections, thereby leaving a raised image on the rubber that can receive ink and producing the desired continuous image. However, such digitally imaged rubber rolls or sleeves are expensive. Moreover, the maximum resolution normally obtainable with a photopolymer sleeve is about 200 to 220 dots per linear inch, while the maximum resolution obtainable with digitally imaged rubber rolls or sleeves is normally only about 120 to 135 dots per linear inch. Thus, digitally imaged rubber rolls or sleeves generally cannot achieve images with resolutions as high as the resolution obtainable with a photopolymer covered sleeve.

Moreover, photopolymer plates cannot typically be engraved directly using lasers because the laser will burn the photopolymer. However, another way of forming an image on a plate involves a digital photopolymer plate that has been wound around and attached to a printing sleeve or printing cylinder by sticky backs. Such photopolymer plates have trade names such as NYLOFLEX®, CYREL® and KOR POLYFIBRON® and typically have durometers in the range of 45 to 55 Shore A. The exposed surface of the plate is then coated with a mask layer of carbon black material. An Yttrium-Aluminum-Garnet (YAG) laser, which is a particular kind of laser that is sensitive to black color, can be used to ablate the black masked material and define the desired image where the black mask has been ablated by the laser. Thereafter, ultraviolet light can be applied to the rotating sleeve or cylinder to form what is known as a digital photopolymer plate. This digitally imaged photopolymer plate is then placed in a solvent bath and scrubbed to remove the unpolymerized (unexposed) areas beneath the black mask to create a relief image. The imaged plate is next post-cured with UV light to cure and harden the unexposed areas (such as the floor) of the plate. The raised image will thus be capable of receiving ink and producing the desired printed image. As with the plates discussed above, a gap typically exits where the opposite edges of the imaged digital photopolymer plate come together.

To eliminate the gap, prior to forming the image, the attached sheet of photopolymer is wrapped around the sleeve or cylinder so that the ends of the sheet butt together to form a seam. To produce a seamless photopolymer layer that is wrapped around a sleeve or cylinder, the sleeve or cylinder carrying the butting ends of the wrapped photopolymer sheet is subjected to high temperatures (e.g., 250° F.) by baking in an oven until the butting ends have become fused together. Upon removal from the high temperature treatment (an expensive and time consuming process), it is often necessary to grind and polish the fused structure until it is smooth and in round with the rest of the sleeve or cylinder. These are known as LASER SEAMEX® photopolymer sleeves, but are very costly. After such LASER SEAMEX® photopolymer sleeves are ground and polished, the exposed surface of the sleeve is then ready to be imaged as described above using a mask layer of carbon black material and a YAG laser to define the desired image.

### SUMMARY OF THE INVENTION

In accordance with one embodiment of the present invention, a method is provided for forming a photopolymer layer on a printing substrate (e.g., printing sleeve or cylinder) having a generally cylindrical surface.

The method includes providing a composition comprising a photopolymer and at least one monomer bonded (e.g., covalent bonds, ionic bonds, etc.) to the photopolymer. The composition, in one embodiment, has a viscosity of between about 25 centipoise to about 35 centipoise. In some embodiments, the photopolymer is formed from a monomer selected from the group consisting of amides, acrylamides, methacrylamides, esters, urethanes, acrylates, methacrylates, butadienes, or combinations thereof. In addition, in some embodiments, the monomer or monomers bonded to the photopolymer contain a carboxyl group, such as acrylates, methacrylates, or combinations thereof. The composition may also contain other components, such as photoinitiators, photosensitizers, viscosity-modifiers, or combinations thereof.

The method also includes spraying the composition onto the rotating generally cylindrical surface of the printing substrate to produce a seamless and continuous layer thereon. In one embodiment, for example, spraying can be accomplished using a spray nozzle. The spray nozzle can be positioned between about 2 inches to about 10 inches, and in some embodiments, between about 2 inches to about 4 inches from the rotating generally cylindrical surface. In addition, the spraying nozzle may be held stationary or moved in a certain direction during spraying.

In some instances, once the layer is formed, it is then cured. Thus, the resulting photopolymer layer is seamless and continuous and, in some embodiments, can have a hardness of between about 50 to about 70 Shore A.

In addition, in some embodiments, the method can also include applying a layer of carbon black on the photopolymer layer. The carbon black layer may then be ablated to produce a desired image therein, and then exposed to actinic UV radiation. The photopolymer layer can then be washed out to form printing matrices.

In accordance with another embodiment of the present invention, a flexographic printing substrate (e.g., printing sleeve or cylinder) is also provided. The substrate comprises an elongated core member having a generally cylindrical inner surface defining a hollow internal region and a generally cylindrical outer surface. The core member also has a central rotational axis disposed in the hollow region. The inner surface of the core member defines a diameter at each point along the length thereof in a direction transverse to the rotational axis. Moreover, the core member is formed of a diametrically expandable, high rigidity material, such as fiberglass.

Further, the flexographic printing substrate also includes a seamless and continuous photopolymer layer that has an outer surface configured to be imaged to form printing matrices. The outer surface of the photopolymer layer faces away from the outer surface of the core member. In addition, the photopolymer layer also has an inner surface that faces towards the outer surface of the core member. The photopolymer layer has a hardness between about 50 to about 70 Shore A.

In some embodiments, the flexographic printing substrate comprises a compressible generally cylindrical layer that has an outer surface facing the inner surface of the photopolymer layer.

Other features and aspects of the present invention are discussed in greater detail below.

### BRIEF DESCRIPTION OF THE DRAWINGS

FIG. 1 is a schematic representation of one embodiment of a method of the present invention;

FIGS. 2 and 3 are schematic representations of the components shown in FIG. 1 and/or used in performing additional steps of the method of FIG. 1;

FIG. 4 is a schematic representation of an elevated perspective view of a flexographic printing sleeve of one embodiment of the present invention that is mounted on an air-pressurized mandrel for a flexographic printing machine;

FIG. 5 is a schematic representation of an elevated perspective view of a flexographic printing cylinder of one embodiment of the present invention; and

FIGS. 6A-6E are schematic representations of sections of flexographic printing sleeves and/or cylinders formed according to one embodiment of the method of the present invention.

Repeat use of references characters in the present specification and drawings is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction.

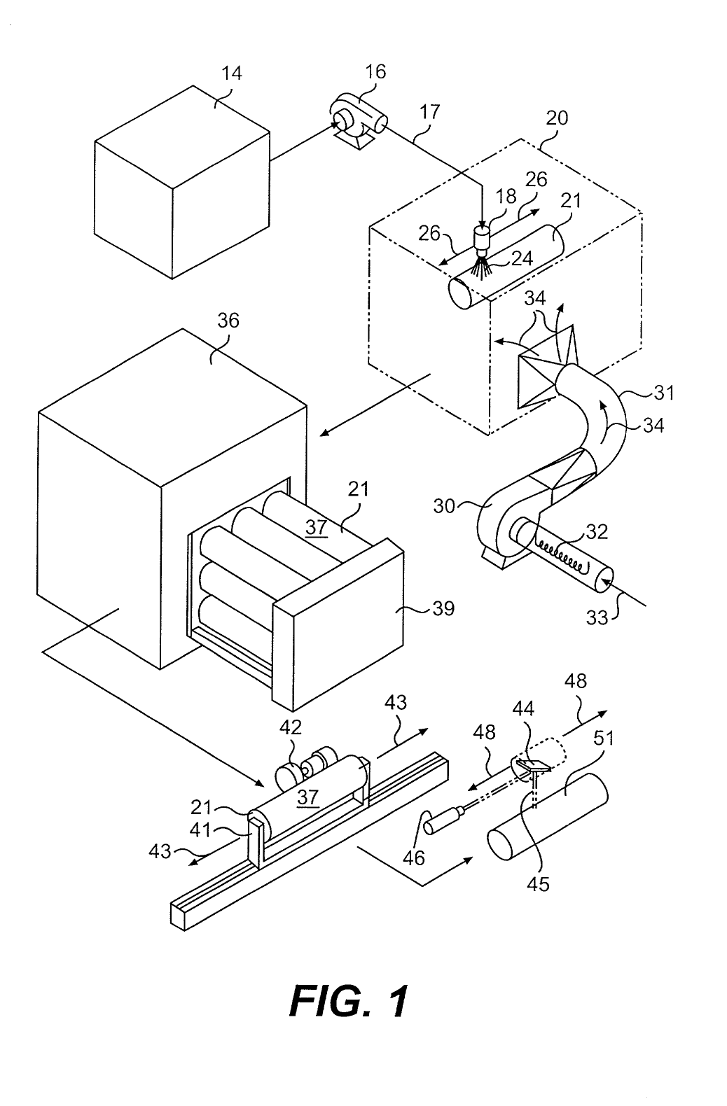

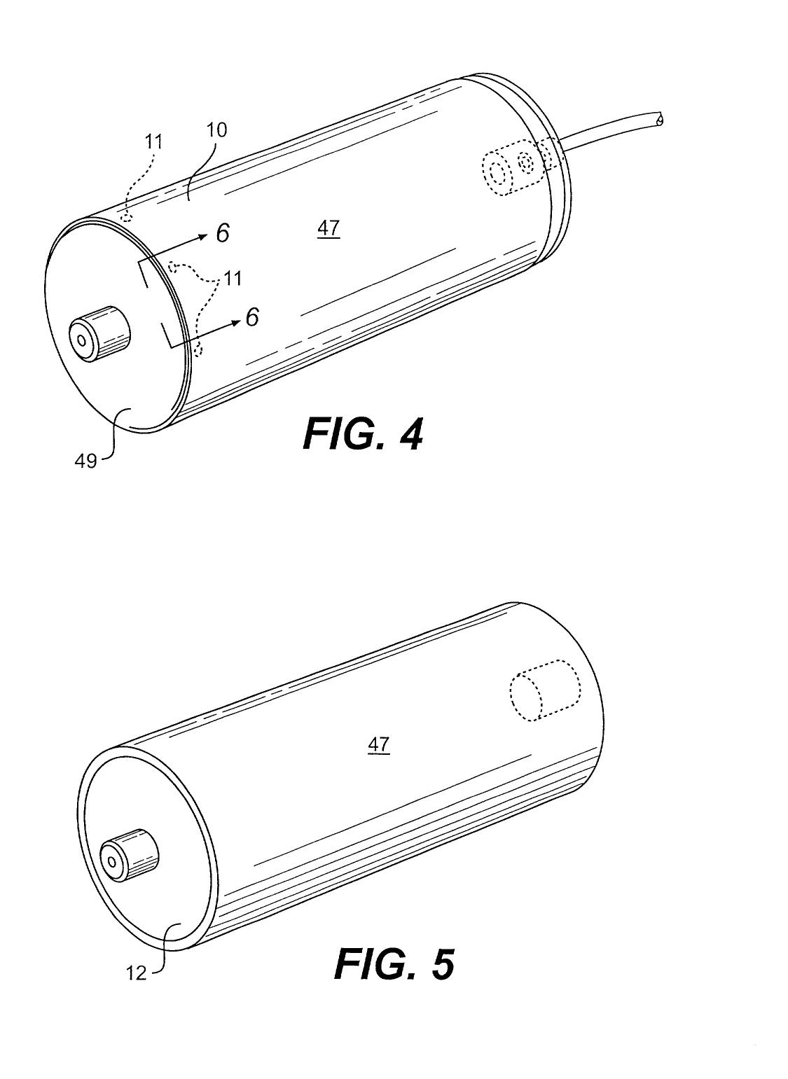

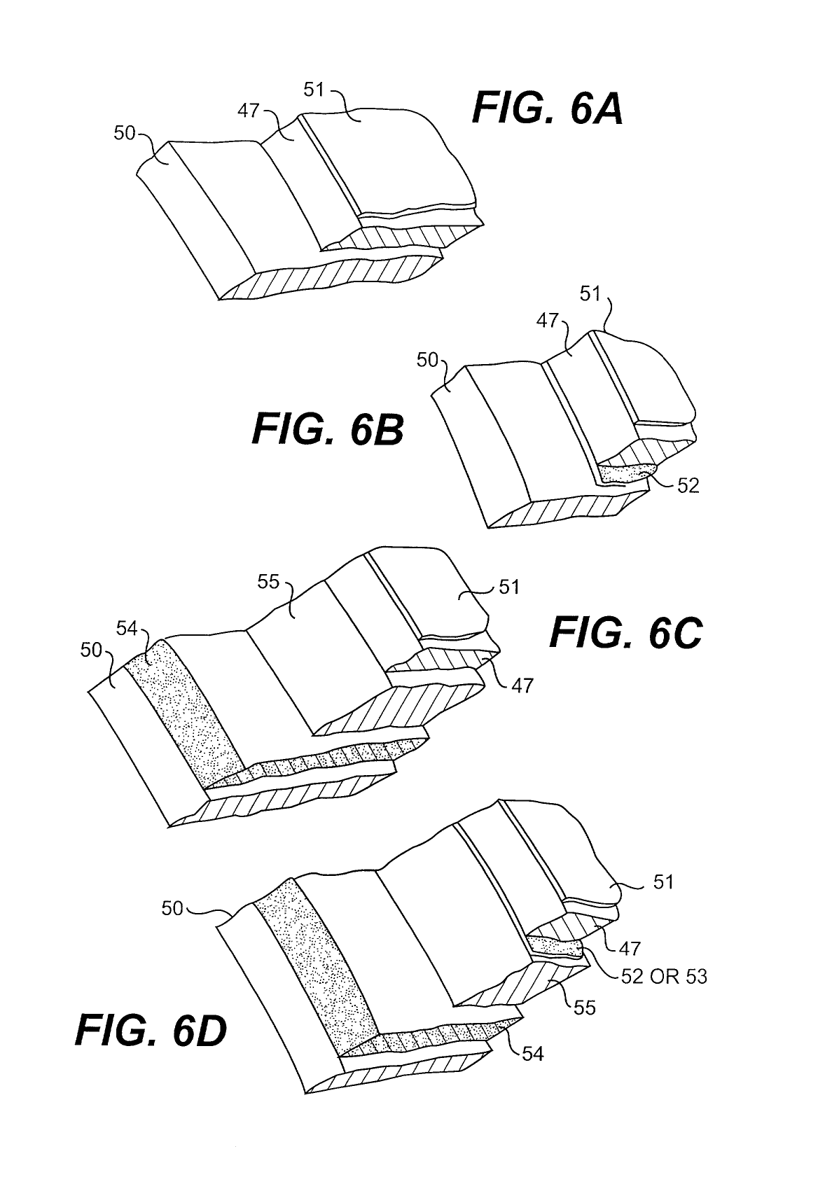

Referring to FIG. 1, one embodiment of a process of the present invention is illustrated for spraying a liquid photopolymer composition onto a generally cylindrical substrate, such as a printing sleeve 10 (FIG. 4) or printing cylinder 12 (FIG. 5). Any of a variety of printing sleeves and/or cylinders can be sprayed with a composition in accordance with the present invention. For instance, printing sleeves made from fiberglass, DUPONT® MYLAR®, tri-laminate KEVLAR®, nickel, copper, etc., can be used in the present invention. Moreover, sleeves with inner openings shaped as a cylinder (so-called parallel sleeves) and sleeves with inner openings having a slight conical shape (so-called tapered sleeves) may be spray coated with a photopolymer composition in accordance with the present invention. Further, various printing cylinders can also be sprayed with a composition according to the present invention, such as steel cylinders, steel cylinders coated with nickel or copper, aluminum cylinders, aluminum cylinders coated with nickel or copper, rubber cylinders, etc.

In one embodiment, as shown in FIG. 1, various components are first mixed together in a reservoir 14 or other mixing apparatus to form the photopolymer composition. In general, any of a variety of materials can generally be utilized to form the photopolymer composition. For instance, one embodiment of a photopolymer composition that can be used in the present invention includes a photopolymer and at least one monomer that is grafted (i.e., bonded) to the photopolymer.

In general, any of a variety of photopolymers can be used in the photopolymer composition. For example, in some instances, the photopolymer can be provided in the form of a polymer sheet that is dissolved in a carrier solvent. In other embodiments, the photopolymer need not be dissolved in a carrier solvent and can be directly mixed with other components and/or directly applied onto a printing sleeve or cylinder. Some examples of suitable photopolymers that can be used in the present invention include, but are not limited to, homopolymers or interpolymers (i.e., copolymers, terpolymers, etc.) formed from a monomer selected from the group consisting of amides, acrylamides, methacrylamides, esters, urethanes, acrylates, methacrylates, butadienes, or combinations thereof. For example, in one embodiment, an amide, acrylamide-based photopolymer sheet sold under the name BASF NYLOPRINT® S/83 by BASF Charlotte, N.C., can be utilized. In another embodiment, a mixed acrylate and methacrylate-ester-based photopolymer sheet sold under the name FHA-170 NYLOFLEX® by BASF Charlotte, N.C., can be utilized.

Although not required, as stated above, a carrier solvent can sometimes aid in dissolving the photopolymer for further mixing and/or for application to the printing sleeve or cylinder. Any of a variety of carrier solvents capable of substantially dissolving a photopolymer can generally be utilized in the present invention. For example, aqueous solvents, such as water or alcohol solutions can be used in the present invention if desired. Some commercially available alcohol solutions that can be used as the carrier solvent include, but are not limited to, OPTISOL® made by DuPont, NutriClean® made by Savolite Inc. of Seattle, Wash., and SOLVIT® made by Polyfibron. Moreover, in one embodiment, an alcohol solution containing about 80% by volume denatured ethanol or ethyl alcohol and about 20% by volume water can be used as the carrier solvent.

As stated above, besides containing a photopolymer, the photopolymer composition used in the present invention also includes at least one monomer that is capable of being bonded to the photopolymer. In particular, the monomer can be utilized to substantially maintain or reduce the hardness of the photopolymer when cured so that it can be more readily applied to a printing sleeve or cylinder in accordance with the present invention. For example, in some embodiments, a monomer is bonded to a photopolymer (e.g., NYLOFLEX®) having an initial hardness value that is between about 50 Shore A to about 55 Shore A. After the monomer is bonded to the photopolymer and cured, the resulting hardness value is substantially maintained or reduced, such as between a hardness value of about 50 Shore A to about 70 Shore A, and in some embodiment, between about 50 Shore A to about 65 Shore A.

A variety of monomers may generally be utilized to bond to the photopolymer composition of the present invention. For instance, in some embodiments, monomers that contain a carboxyl group, such as acrylate or methacrylate monomers, may be useful in the present invention. Some examples of acrylate and methacrylate monomers that may be suitable include, but are not limited to, methyl methacrylate (MMA), ethyl methacrylate (EMA), butyl methacrylate (BMA); 2-ethylhexyl methacrylate, methyl acrylate (MA), ethyl acrylate (EA), butyl acrylate (BA), 2-ethylhexyl acrylate, 2-hydroxyethyl methacrylate (HEMA), 2-hydroxyethyl acrylate (HEA), methacrylic acid (MAA), acrylic acid (AA), esters of acrylic and methacrylic acids wherein the alcohol group contains from 1 to 18 carbon atoms, nitrites and amides of acrylic and methacrylic acids, glycidyl acrylate and methacrylate, aminoethyl methacrylate, aminoethyl acrylate, t-butyl aminoethyl methacrylate, t-butyl acrylate, 1,5-pentanediol diacrylate, N,N-diethylaminoethyl acrylate, ethylene glycol diacrylate, 1,4-butanediol diacrylate, diethylene glycol diacrylate, hexamethylene glycol diacrylate, 1,3-propanediol diacrylate, decamethylene glycol diacrylate, decamethylene glycol dimethacrylate, 1,4-cyclohexanediol diacrylate, 2,2-dimethylolpropane diacrylate, glycerol diacrylate, tripropylene glycol diacrylate, glycerol triacrylate, trimethylolpropane triacrylate, polyoxyethylated trimethylolpropane triacrylate and trimethacrylate, 2,2-di(p-hydroxyphenyl)-propane diacrylate, 2,2-di-(p-hydroxyphenyl)-propane dimethacrylate, triethylene glycol diacrylate; polyoxyethyl-2,2-di-(p-hydroxyphenyl)-propane dimethacrylate; di-(3-methacryloxy-2-hydroxypropyl)ether of bisphenol-A, di-(2-methacryloxyethyl) ether of bisphenol-A, di-(3-acryloxy-2-hydroxypropyl) ether of bisphenol-A, di-(2-acryloxyethyl) ether of bisphenol-A, di-(3-methacryloxy-2-hydroxypropyl) ether of tetrachloro-bisphenol-A, di-(2-methacryloxyethyl) ether of tetrachloro-bisphenol-A, di-(3-methacryloxy-2-hydroxypropyl) ether of tetrabromo-bisphenol-A, di-(2-methacryloxyethyl) ether of tetrabromo-bisphenol-A, di-(3-methacryloxy-2-hydroxypropyl) ether of 1,4-butanediol, di-(3-methacryloxy-2-hydroxypropyl) ether of diphenolic acid, triethylene glycol dimethacrylate, polyoxypropyl-1-trimethylol propane triacrylate, ethylene glycol dimethacrylate, butylene glycol dimethacrylate, 1,3-propanediol dimethacrylate, 1,2,4-butanetriol trimethacrylate, 2,2,4-trimethyl-1,3-pentanediol dimethacrylate, 1-phenyl ethylene-1,2-dimethacrylate, trimethylol propane trimethacrylate, 1,5-pentanediol dimethacrylate, 4-benzenediol dimethacrylate, pentaerythritol triacrylate, pentaerythritol tetraacrylate, pentaerythritol pentaacrylate, pentaerythritol trimethacrylate, pentaerythritol tetramethacrylate, pentaerythritol pentamethacrylate, and the like.

In addition, various metallic acrylates or methacrylates can also be useful in the present invention. For instance, in some embodiments, an acrylate or methacrylate monomer that contains zinc may be used in the photopolymer composition. Thus, one portion of the acrylate or methacrylate can form an ionic bond with one photopolymer, while another portion of the acrylate or methacrylate can form an ionic bond with another photopolymer. In this manner, the zinc-containing monomer can act as a crosslinking agent for the two photopolymers.

For example, in one particular embodiment, zinc diacrylate or zinc dimethacrylate monomers having the following structures can be used:

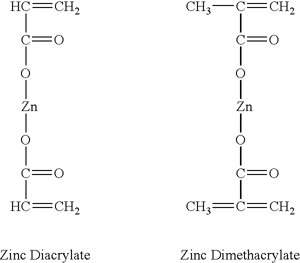

Commercially available examples of such zinc acrylates can be obtained from Sartomer (Exton, Pa.) under the names Saret® 633 or SR-633 (zinc diacrylate) and Saret®634 (zinc dimethacrylate).

Other suitable carboxyl group-containing monomers may include, but are not limited to, itaconic acid (IA) and itaconic acid anhydride, itaconic acid half ester and itaconic imide; maleic acid and maleic acid anhydride, maleic acid half ester and maleimide, vinyl acetate, and the like. Further other suitable monomers may include, but are not limited to, vinyl methyl ether; styrene; alpha-methyl styrene; vinyl chloride; butadiene; isoprene; vinyl pyrrolidone; diallyl fumarate; 4-diisopropenyl benzene; 1,3,5-triisopropenyl benzene; peroxides; sulfur-containing compounds; and the like. In addition, some monomers that might be suitable in the present invention are also described in U.S. Pat. No. 3,380,831, which is incorporated herein in its entirety by reference thereto for all purposes.

In addition, the photopolymer composition can also contain various other optional components, such as a photoinitiator component, a photosensitizer component, a Viscosity-modifier component, a compressible microsphere or bubble component, etc. For example, compressible microspheres or bubbles, can be used to form a compressible photopolymer that is used to reduce the need for deploying a compressible layer beneath the photopolymer layer of the sleeve or cylinder. The viscosity modifier component can, in some embodiments, contain viscosity-modifying monomers, such as “BAKELITE” phenoxy resin (Union Carbide), ethoxylated trimethyl propane triacrylate, polyethylene glycol diacrylates, pentaerythritol triacrylate, pentaerythritol tetraacrylate, pentaerythritol pentaacrylate, pentaerythritol trimethacrylate, pentaerythritol tetramethacrylate, pentaerythritol pentamethacrylate, and the like. For example, in one particular embodiment, dispentaerythritol pentaacrylate can be used in the photopolymer composition, which is commercially available from Sartomer (Exton, Pa.) under the name Saret® 399 or SR-399.

Moreover, as stated, the composition can include photoinitiators, such as benzoin, benzoin alkyl ethers, alpha-methylolbenzoin and its ethers, alpha-methylbenzoin, diketones and their derivatives, monoketals, and substituted quinones, such as anthraquinone. Further, the composition can also contain photosensitizers, such as potassium dichromate. For instance, when utilized, the photosensitizer and photoinitiator components can each be utilized in an amount of about 0. 1 % to about 5% by weight of the photopolymer composition.

For instance, in one particular embodiment, the photopolymer composition can be formed from 48.00 parts by weight FHA-1 70 NYLOFLEX® by BASF Charlotte, N.C., 50.00 parts by weight OPTISOL® made by DuPont®, 3.85 parts by weight Saret® 399, 0.10 parts by weight Saret®634 (0.1% in OPTISOL®, dissolved by heating the OPTISOL® to about 80° F), and 0.05 parts by weight benzoyl peroxide (0.1% in OPTISOL®).

Referring again to FIG. 1, once the components of the photopolymer composition, such as described above, are mixed together, the resulting liquid photopolymer composition can be pumped from the reservoir 14 by a pump 16 to a spray nozzle 18 via pressure tubing 17. As shown, the spray nozzle 18 is disposed inside a spray chamber 20 that is schematically indicated by the cube defined by the chain-dashed lines and designated by the numeral 20. Any of a variety of known spraying nozzles can generally be used to apply the photopolymer composition in accordance with the present invention.

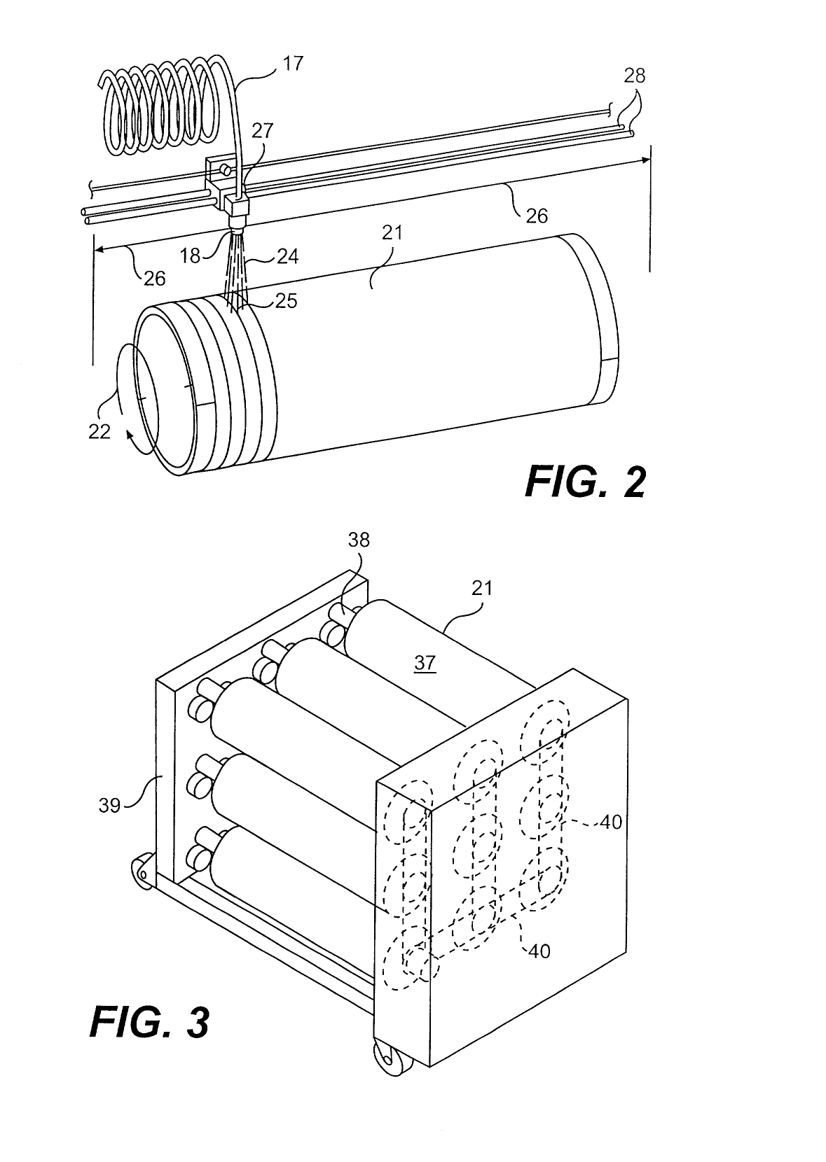

Inside the spray chamber 20, a cylindrical substrate 21 in the form of a cylinder or cylindrical sleeve can be mounted on a rotatable mandrel to rotate beneath the spray nozzle 18. Rotation of the cylindrical substrate 21, as schematically indicated in FIG. 2 by the arrow designated by the numeral 22, typically occurs at about 54 to 56 revolutions per minute (rpms), but can run as high as 200 rpms.

As shown in FIG. 2, for example, the liquid photopolymer composition 24 can be pumped out of the nozzle 18 at a pressure within the range of about 45 to 65 pounds per square inch. The spray pattern 25 of the liquid photopolymer composition is directed along a radius of the cylindrical substrate 21. It should be understood, however, that in some embodiments, an adhesive can first be applied (also as by spraying for example) to facilitate attachment of the liquid photopolymer composition 24 to the cylindrical substrate 21. In addition, as described in more detail below, a compressible layer can also be applied to the cylindrical substrate 21 prior to spraying the photopolymer composition 24 thereon to minimize “dot gain.” This disposes a compressible layer beneath the seamless, cylindrical photopolymer layer. Suitable compressible layers can include, but are not limited to, a compressible foam layer, an aerated (i.e., containing spheres or bubbles) photopolymer composition, and the like.

The distance between the exit orifices of the nozzle 18 and the exterior surface of the cylindrical substrate 21 is typically in the range of between about 2 to about 10 inches, and in some embodiments, between about 2 to about 4 inches. In one embodiment, when the liquid photopolymer composition 24 is sprayed onto the surface of the rotating cylindrical substrate 21, the exit orifices of the spray nozzle 18 apply the liquid photopolymer composition 24 so that it wets an area 25 of circular shape, which in this embodiment, is about 2 inches in diameter. In addition, as schematically indicated by the double-ended arrow designated by the numeral 26 in FIGS. 1 and 2, the nozzle 18 is mounted to a carriage 27 that moves on rails 28 linearly back and forth parallel to the exterior surface of cylindrical substrate 21. Moreover, if desired, the nozzle 18 can spray the composition onto the rotating cylindrical substrate 21 as the nozzle 18 moves back and forth in both directions. In other embodiments, however, the nozzle 18 sprays the composition only while the carriage is moving in one direction. Further, it is also contemplated that the nozzle 18 may be kept stationary while a carriage is provided to move the cylindrical substrate. Further, it is also contemplated that more than one nozzle 18 can be used and that one or more nozzles 18 and the substrate 21 can be moving at the same time using various motors and relays under control of a computer if desired.

Referring again to FIG. 1, while the liquid photopolymer composition 24 is being sprayed onto the cylindrical substrate 21, a drying mechanism can be used to heat the rotating cylindrical substrate 21 while the photopolymer is being sprayed onto substrate 21. This heating can dry the substrate 21 and/or remove the carrier solvent (if utilized) from the photopolymer composition. In one embodiment, the drying mechanism can use hot air to heat the interior of the spray chamber 20 containing the cylindrical substrate 21 to a temperature of at least about 100° F. An air blower 30 can be provided and have an outlet connected via suitable ducting 31 to spray chamber 20 to blow air into the interior of the spray chamber 20. The air blower 30 can be provided with a heating element 32 for heating the air that enters the air blower 30 before the air is blown into the spray chamber 20. In this way, the temperature inside the spray chamber 20 can be controlled, and this temperature is desirably maintained at no less than about 100° F. The arrow designated by the numeral 33 represents ambient air that is heated by the heating element 32 of the air blower 30. The arrows designated by the numeral 34 represent the heated air that is blown into the interior of the spray chamber 20 by the blower 30.

In addition to or instead of using hot air, the rotating cylindrical substrate 21 can also be heated using a continuous heat source. In this way, the temperature inside the spray chamber 20 can be further controlled, and this temperature is desirably maintained at no less than about 100° F.

In general, a variety of parameters, such as the number of nozzle passes, wet volume of the liquid photopolymer composition applied, viscosity of the liquid photopolymer composition, the pressure of the liquid photopolymer composition during application, rotation rate of the cylindrical substrate, nozzle distance from the surface of the cylindrical substrate, etc., can be varied to control the resulting thickness of the cylindrical photopolymer layer deposited. For instance, in one embodiment, 250 nozzle passes and a wet volume of approximately 0.8 gallons to about 1.0 gallon can be used to produce a coating having a thickness of approximately 0.078 inches. If desired, the viscosity of the photopolymer composition 24 can be varied to correspond to the rotation rate of the cylindrical substrate 21.

After application of the photopolymer composition 24, the resulting sleeve or cylinder covered with photopolymer can also be transferred into a vertical or horizontal oven 36 for further drying and/or evaporation of the solvent (if utilized). As shown in FIG. 3 for example, each cylindrical substrate 21 to which has been applied an unfinished, seamless, cylindrical layer 37 of photopolymer composition is mounted on a mandrel 38 that is rotatably carried by a dolly 39. The dolly 39 is mobile so that it can be wheeled into and out of the oven 36. Each mandrel 38 is rotated by driven belts 40 or chains 40 in order to rotate the cylindrical substrates 21 during their stay within the oven 36 in order to promote even drying and uniformity of the thickness of the unfinished photopolymer layer 37.

After being dried, the exterior surface of each unfinished, seamless, cylindrical layer 37 of photopolymer composition is ready to receive a carbon black film prior to being digitally imaged and processed to form the printing surface of a flexographic printing sleeve or cylinder. In some instances, it might be desired to subject the surface of the unfinished photopolymer layer 37 to grinding and/or polishing. A variety of mechanisms, such as grinders or belt polishers, can be used to accomplish this step. As shown in FIG. 1, the cylindrical substrate 21 can be mounted on a platform 41 that rotates the cylindrical substrate 21 while translating the cylindrical substrate 21 back and forth against the exterior surface of a polisher 42. The linear translation of platform 41 is schematically indicated by the arrows designated by the numeral 43 in FIG. 1. Alternatively, the polisher 42 can move linearly while the platform 41 that rotatably carries the substrate 21 remains stationary, or both the polisher and the platform 41 can move relative to one another.

Once the photopolymer composition layer of the sleeve 10 or cylinder 12 is ground and polished, the finished, seamless cylindrical layer of photopolymer composition can then be further processed, treated or finished as desired, depending on the final application. For instance, in one embodiment, an anti-oxidation layer can be applied. This can take the form of a thin layer of carbon black that is deposited to a thickness in the range of about 10 microns to about 15 microns by any conventional process. Moreover, the seamless, cylindrical layer of photopolymer composition can then be imaged according to methods well known in the art. For instance, the imaging of the photopolymer composition layer can be processed with conventional negatives, digital imaging of black masks, direct digital layering, and the like.

In particular, in one embodiment, a thin layer (e.g., about 10 microns to about 15 microns) of a mask formed of carbon black can first be applied to the polished exterior surface of the cylindrical photopolymer layer. Thereafter, a YAG laser can be utilized to produce an image on the photopolymer composition by removing (ablating) the carbon black mask where the image is to be formed. For instance, as shown in FIG. 1, laser beams 45 generated from a computer-controlled laser 46 can be directed via one or more linearly translating mirrors 44 to ablate the mask 51 in accordance with the images to be formed in the finished, seamless cylindrical photopolymer layer 47 (not shown in FIG. 1). The linear translation of mirror 44 is schematically indicated by the arrows designated by the numeral 48 in FIG. 1 and can be controlled by a computer (not shown).

After ablating the mask 51 with the laser 46 to form the desired image in the ablated portions of the mask 51, the sleeve is bathed in UV actinic light to polymerize (harden) the portions of the photopolymer layer that are no longer covered by the black mask 51. This UV light bath process typically takes about 10 to about 15 minutes, depending upon the UV light set up. Thereafter, the portions of the layer of photopolymer that were not exposed to the laser and the UV light bath (because they remained beneath the black mask 51) can then be washed out by utilizing a suitable solvent treatment, such as an alcohol solution (e.g., OPTISOL®). The resulting imaged cylindrical photopolymer layer can then be dried, finished, and used in the desired printing application.

Various embodiments of printing sleeves and/or solid cylinders formed with seamless, cylindrical photopolymer layers in accordance with the above-described process are illustrated in FIGS. 4 through 6E. Referring to FIG. 4, for example, a printing sleeve 10 containing a finished, seamless, cylindrical layer 47 of photopolymer composition formed according to the present invention is illustrated as being mounted on a vacuum mandrel 49, which includes a plurality of air holes 11 (shown in dashed line) for air mounting of the sleeve 10. Moreover, referring to FIG. 5, a steel or aluminum cylinder 12 containing a finished, seamless, cylindrical layer 47 of photopolymer composition in accordance with the present invention is also illustrated.

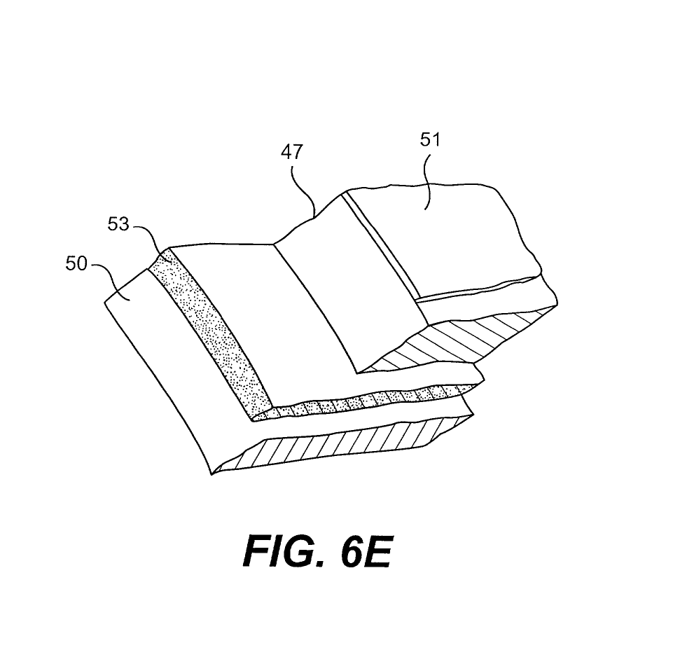

In general, referring to FIGS. 6A through 6E in which the proportions of the various layers have been exaggerated in order to facilitate explanation of the invention, various embodiments of the sleeve and cylinder of FIGS. 4 and 5 are also schematically illustrated. For ease of illustration and to avoid unnecessary duplication, the underlying core will be deemed part of a sleeve rather than a cylinder.

For example, referring to FIGS. 6A, 6B and 6E, one embodiment of a printing sleeve or cylinder that includes a seamless, cylindrical photopolymer layer 47 having a thickness of about 0.040 inches and formed in accordance with the present invention is schematically illustrated. As shown in FIG. 6A, the printing sleeve or cylinder includes a first layer 47 of a photopolymer composition formed in accordance with the present invention and having a thickness of about 0.040 inches disposed atop and directly onto the exterior surface of the core layer 50 of a sleeve or cylinder. A black mask layer 51 having a thickness between about 10 to 15 microns is applied on top of the finished exterior surface of the seamless, cylindrical layer 47 of photopolymer composition. Moreover, as shown schematically in FIG. 6B, the printing sleeve or cylinder can also include a first adhesive layer 52 formed in accordance with the present invention and having a thickness of about 0.005 inches located between the bottom of the photopolymer composition layer 47 and the exterior surface of the core 50 of the sleeve or cylinder. In lieu of an adhesive layer, the printing sleeve or cylinder can include a compressible layer 53, such as schematically shown in FIG. 6E, having a thickness of about 0.020 inches and disposed between the bottom of the seamless, cylindrical layer 47 of photopolymer composition and the exterior surface of the core 50 of the sleeve or cylinder.

Referring to FIGS. 6C and 6D, additional embodiments of printing sleeves or cylinders of the present invention are schematically illustrated. As shown in FIG. 6C, the printing sleeve or cylinder includes an inner core 50 of wound fiberglass having a thickness of about 0.040 inches, a second layer 54 of polyurethane foam having a thickness of about 0.040 inches, a third layer 55 of rigid polyurethane having a thickness that can be varied depending on the desired repeat but typically having a thickness of at least about 0.080 inches. A photopolymer composition layer 47 formed in accordance with the present invention and having a thickness of about 0.040 inches is then applied to the exterior surface of the third layer 55 of rigid polyurethane. In an alternative embodiment as shown schematically in FIG. 6D, an adhesive layer 52 or compressible layer 53 can also be applied between the third layer 55 of rigid polyurethane mentioned above and the seamless, cylindrical layer 47 of photopolymer composition.

### EXAMPLE

The ability of a liquid photopolymer composition to be sprayed onto a seamless printing sleeve was demonstrated. A liquid photopolymer composition was first formed according to the present invention to include 45.44% by weight ethanol, 30.2% by weight photopolymer, 13% by weight monomers bonded to the photopolymer, and 11.36% by weight other additives including viscosity-modifying monomers, photosensitizers and photoinitiators.

In particular, a 25 inches×32 inches×0.038 inches sheet of BASF NYLOPRINT® S/83, a photopolymer, an amide, acrylamide-based photopolymer of about 50 to 60 Shore D hardness, was initially provided. As known, such sheets are provided on one side with a sealed steel backing measuring 0.010 inches thick and are imbued with between about 0.1 to about 0.5% by weight photosensitizers (e.g., potassium dichromate) and 0.1 to 5.0% by weight photoinitiators. A carrier solvent, such a solution containing 80% by volume denatured ethanol or ethyl alcohol plus 20% by volume water, was then applied to the sheet to dissolve the photopolymer. Thereafter, monomers were added in order to reduce the Shore hardness, and other additives, such as a viscosity-modifying component, were mixed with the alcohol-based photopolymer composition. The viscosity of the resulting photopolymer composition was believed in the range of about 25 to about 35 centipoise.

The liquid photopolymer composition formed above was then dispensed into a spray nozzle (i.e., high volume, low-pressure spray nozzle, such as PAINTER'S CHOICE PROFESSIONAL® spray gun Model No. FR-103 made in Taiwan) and sprayed onto a cylindrical core of wound fiberglass having an outside diameter of 6.196 inches, an inside diameter of 6.276 inches, and a length of 24 inches. The core was rotated at a rate of about 59 rpms during the spraying application of the liquid photopolymer composition. The nozzle was held at a distance of about 8 inches to about 10 inches during spraying. Moreover, the photopolymer composition was sprayed onto the exterior surface of the sleeve, beginning at a pressure of about 55 pounds per square inch, until about two thirds of the desired thickness of 0.078 inches of photopolymer layer was applied. Thereafter, the photopolymer composition was sprayed onto the exterior surface of the sleeve at a pressure of about 45 pounds per square inch until the last one third of the desired thickness of 0.078 inches of photopolymer layer was applied.

During spraying, the nozzle passed 250 times from one end of the core to the other end of the core, and approximately 0.8 gallons of the liquid photopolymer composition was sprayed onto the core. The resulting thickness of the photopolymer composition that had been applied to the core was about 0.078 inches. The resulting core was rotated for 24 hours in an oven maintained at a temperature of about 100° F. The exterior surface of the seamless, cylindrical photopolymer layer was polished and made ready for subsequent processing to form a printing image thereon. The resulting printing sleeve had a durometer reading of 65 to 70 Shore A. It is believed that the resulting printing sleeve would have a useful life of several million impressions. It is also believed that the resulting printing sleeve would lend itself to high quality flexographic printing comparable to gravure and wet offset process colors with excellent ink transfer and resistance to ethyl acetate, methyl ethyl ketone and other alcohols found in solvent-based and water-based flexographic inks.

Digital imaging is becoming more prevalent in the industry. The digital imaging of a sleeve or cylinder that is pre-coated with a continuous, seamless cylindrical photopolymer layer according to the present invention improves the efficiency of the digital imaging process relative to the traditional imaging process that involves having to attach a virgin, non-cured photopolymer plate with double sided tape and then having to apply a mask. Additionally, by having a continuous photopolymer coating that adheres well to the underlying sleeve or cylinder as in the present invention, there is no possibility of the photopolymer plate or sticky back lifting and the photopolymer plate becoming unattached.

These and other modifications and variations of the present invention may be practiced by those of ordinary skill in the art, without departing from the spirit and scope of the present invention. In addition, it should be understood that aspects of the various embodiments may be interchanged either in whole or in part. Furthermore, those of ordinary skill in the art will appreciate that the foregoing description is by way of example only, and is not intended to limit the invention so further described in such appended claims.

What is claimed is:

1. A method of forming a photopolymer layer on a printing substrate having a generally cylindrical surface, said method comprising:
providing a composition comprising a photopolymer and at least one monomer bonded to said photopolymer;
rotating the generally cylindrical surface of the printing substrate;
spraying said composition onto said rotating generally cylindrical surface of the printing substrate to produce a seamless and continuous layer thereon; and
curing said photopolymer layer.

2. A method as defined in claim 1, wherein the photopolymer layer has a hardness of about 50 to about 70 Shore A.

3. A method as defined in claim 1, further comprising applying a layer of carbon black on said photopolymer layer.

4. A method as defined in claim 4, further comprising:
ablating said carbon black layer to produce a desired image therein;
exposing said ablated layer of photopolymer to actinic UV radiation; and
washing out said photopolymer layer to form printing matrices.

5. A method as defined in claim 1, further comprising forming a compressible layer on said generally cylindrical surface prior to spraying said composition thereon.

6. A method as defined in claim 1, wherein said spraying is accomplished using a spray nozzle.

7. A method as defined in claim 1, wherein said spray nozzle is positioned between about 2 inches to about 10 inches from said rotating generally cylindrical surface during spraying.

8. A method as defined in claim 7, wherein said spray nozzle is positioned between about 2 inches to about 4 inches from said rotating generally cylindrical surface during spraying.

9. A method as defined in claim 7, wherein said spray nozzle is moved in a certain direction during spraying.

10. A method as defined in claim 7, wherein said spray nozzle is held stationary during spraying.

11. A method as defined in claim 1, wherein said photopolymer is dissolved in a carrier solvent prior to spraying said composition on said rotating generally cylindrical surface.

12. A method as defined in claim 1, wherein said photopolymer is formed from a monomer selected from the group consisting of amides, acrylamides, methacrylamides, esters, urethanes, acrylates, methacrylates, butadienes, or combinations thereof.

13. A method as defined in claim 12, wherein said photopolymer is formed from amide and acrylamide monomers.

14. A method as defined in claim 12, wherein said photopolymer is formed from acrylate, methyacrylate, and ester monomers.

15. A method as defined in claim 1, wherein said at least one monomer bonded to said photopolymer is selected from the group consisting of acrylates, methacrylates, and combinations thereof.

16. A method as defined in claim 1, wherein said at least one monomer bonded to said photopolymer includes an acrylate or methacrylate containing a metal atom.

17. A method as defined in claim 1, wherein said at least one monomer is ionically bonded to said photopolymer.

18. A method as defined in claim 1, wherein said composition further comprises a photoinitiator, a photosensitizer, a viscosity-modifier, or combinations thereof.

19. A method as defined in claim 1, wherein the viscosity of said composition is between about 25 centipoise to about 35 centipoise.

20. A method as defined in claim 1, wherein the printing substrate is a printing cylinder.

21. A method as defined in claim 1, wherein the printing substrate is a printing sleeve.

22. A method of forming a photopolymer layer on a printing sleeve having a generally cylindrical surface, said method comprising:
providing a composition comprising a photopolymer and at least one acrylate or methacrylate monomer bonded to said photopolymer;
rotating the generally cylindrical surface of the printing sleeve;
spraying said composition onto said rotating generally cylindrical surface of the printing sleeve to produce a seamless and continuous layer thereon;
curing said photopolymer layer, wherein the hardness of the cured photopolymer layer is between about 50 to about 70 Shore A;
applying a layer of carbon black on said cured photopolymer layer;
ablating said carbon black layer to produce a desired image therein;
exposing said ablated layer of photopolymer to actinic UV radiation; and
washing out said photopolymer layer to form printing matrices.

23. A method as defined in claim 22, wherein said photopolymer is formed from a monomer selected from the group consisting of amides, acrylamides, methacrylamides, esters, urethanes, acrylates, methacrylates, butadienes, or combinations thereof.

24. A method as defined in claim 22, wherein said at least one monomer bonded to said photopolymer includes an acrylate or methacrylate containing a metal atom.

25. A method as defined in claim 22, wherein said at least one monomer is ionically bonded to said photopolymer.

26. A flexographic printing sleeve comprising:
an elongated core member having a generally cylindrical inner surface defining a hollow internal region and a generally cylindrical outer surface, said core member having a central rotational axis disposed in said hollow region, said inner surface of said core member defining a diameter at each point along the length thereof in a direction transverse to said rotational axis, said core member being formed of a diametrically expandable, high rigidity material; and
a seamless and continuous photopolymer layer carried by said core member such that said photopolymer layer has an inner surface facing towards said outer surface of said core member and an outer surface facing away from said outer surface of said core member, said outer surface of said photopolymer layer being configured to be imaged to form printing matrices, said photopolymer layer having a hardness between about 50 to about 70 Shore A, wherein said photopolymer layer comprises a photopolymer and at least one monomer bonded to said photopolymer.

27. A flexographic printing sleeve as defined in claim 26, further comprising a compressible generally cylindrical layer, said compressible layer having an outer surface disposed against said inner surface of said photopolymer layer.

28. A flexographic printing sleeve as defined in claim 26, wherein said photopolymer is formed from a monomer selected from the group consisting of amides, acrylamides, methacrylamides, esters, urethanes, acrylates, methacrylates, butadienes, or combinations thereof.

29. A flexographic printing sleeve as defined in claim 26, wherein said at least one monomer bonded to said photopolymer is selected from the group consisting of acrylates, methacrylates, and combinations thereof.

30. A flexographic printing sleeve as defined in claim 26, wherein said at least one monomer bonded to said photopolymer includes an acrylate or methacrylate containing a metal atom.

31. A flexographic printing sleeve as defined in claim 26, wherein said at least one monomer is ionically bonded to said photopolymer.
